(19) United States
(12) Patent Application Publication
(10) Pub. No.: US 2026/0188007 A1
(43) Pub. Date: Jul. 2, 2026

(54) SYSTEM FOR ACTIVITY DETECTION AND RELATED METHODS

(71) Applicant: Battelle Energy Alliance, LLC, Idaho Falls, ID (US)

(72) Inventors: Matthew W. Anderson, Idaho Falls, ID (US); Cooper Coldwell, Ponchatoula, LA (US); Denver S. Conger, Idaho Falls, ID (US); Bryton Petersen, Idaho Falls, ID (US); Brendan Jacobson, Rexburg, ID (US); Damon Spencer, Sugar Land, TX (US); Matthew R. Sgambati, Rigby, ID (US)

(21) Appl. No.: 19/126,128

(22) PCT Filed: Nov. 10, 2023
(86) PCT No.: PCT/US2023/079434

§ 371 Date: Apr. 30, 2025

Related U.S. Application Data
(60) Provisional application No. 63/383,208, filed on Nov. 10, 2022.

(51) Int. Cl. G06V 20/40; G06V 10/764; G06V 10/82; G06V 20/52; G06V 40/20

(52) U.S. Cl. CPC G06V 20/41; G06V 10/764; G06V 10/82; G06V 20/52; G06V 40/20; G06V 2201/08

(57) ABSTRACT

An activity detection system may include a video capture device, a processor, and a non-transitory computer-readable medium storing instructions. The instructions may cause the processor to receive training image data including one or more two-dimensional images, each two-dimensional image associated with one or more first activities represented in each respective two-dimensional image, apply machine learning techniques to the training image data to generate a classification model for classifying one or more activities, receive a plurality of video frames received, generate composite image data based on the plurality of video frames, detect, via the at least one classification model, one or more second activities represented in the composite image data, and classify, via the at least one classification model, the one or more second activities detected in the composite image data.

### CROSS-REFERENCE TO RELATED APPLICATIONS

This application is a national phase entry under 35 U.S.C. § 371 of International Patent Application PCT/US2023/079434, filed Nov. 10, 2023, designating the United States of America and published as International Patent Publication WO 2024/103041 A1 on May 16, 2024, which claims the benefit under Article 8 of the Patent Cooperation Treaty of U.S. Patent Application Ser. No. 63/383,208, filed Nov. 10, 2022.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

Embodiments of the present disclosure relate generally to systems and methods for activity detection using machine-learning.

### BACKGROUND

For decades, video surveillance has been an important component in security systems around the world. As video capture devices become increasingly affordable and the quality of video capture devices continues to increase, the amount of video surveillance data that is stored has exploded. For example, in 2019, video surveillance footage generated globally exceeded 2 Exabytes and the volume of video surveillance data generated continues to grow exponentially.

### BRIEF SUMMARY

Some embodiments of the present disclosure include an activity detection system including a video capture device, at least one processor and at least one non-transitory computer-readable medium storing instructions. The instructions, when executed by the at least one processor, cause the at least one processor to receive training image data including one or more two-dimensional images, each two-dimensional image associated with one or more first activities represented in each respective two-dimensional image, apply one or more machine learning techniques to the training image data to generate at least one classification model for classifying one or more activities represented in one or more images, receive a plurality of video frames, generate composite image data based, at least in part, on the plurality of video frames, the composite image data representative of a temporal structure of motion represented in the plurality of video frames, detect, via the at least one classification model, one or more second activities represented in the composite image data, and classify, via the at least one classification model, the one or more second activities detected in the composite image data.

Additional embodiments of the present disclosure include a method. The method may include receiving training image data including one or more two-dimensional images, each two-dimensional image associated with one or more first activities represented in each respective two-dimensional image, applying one or more machine learning techniques to the training image data to generate at least one machine learning model for encoding the one or more two-dimensional images into a latent space representation of the one or more two-dimensional images based, at least in part, on one or more activities represented in one or more images, receiving a plurality of video frames, generating composite image data based, at least in part, on the plurality of video frames, the composite image data representative of a temporal structure of motion represented in the plurality of video frames, encoding, via the machine learning model, the composite image data into a latent space representation of the composite image data based, at least in part, on one or more second activities represented in the composite image data, and identifying one or more anomalous activities represented in the composite image data based on the latent space representation of the composite image data.

Further embodiments of the present disclosure may include a non-transitory computer-readable storage medium storing instructions thereon that, when executed by the at least one processor, perform acts including receiving training image data including a plurality of first video frames, providing the training image data to an autoencoder machine learning model to train the auto-encoder machine learning model based, at least in part, on one or more activities represented in the training image data, receiving a plurality of video frames, generating composite image data based, at least in part, on the plurality of video frames, the composite image data representative of a temporal structure of motion represented in the plurality of second video frames, detecting, via the autoencoder machine learning model, one or more second activities represented in the composite image data, and identifying, via the auto-encoder machine learning model, the one or more second activities as anomalous responsive to a determination that the one or more second activities are different from the one or more first activities.

### BRIEF DESCRIPTION OF THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1 is a block diagram of an activity detection system according to one or more embodiments of the present disclosure;

FIG. 2 is a flowchart illustrating a method of operation of an activity detection system;

FIG. 3A illustrates various states of processing a single image time series representation (SITSR) according to one or more embodiments of the present disclosure;

FIG. 3B illustrates additional states of processing a SITSR according to one or more embodiments of the present disclosure;

FIG. 4 shows an image (top) from a set of images depicting a SITSR and an image (bottom) showing the difference between a plurality of images represented by the SITSR, according to one or more embodiments of the present disclosure;

FIG. 5A shows example SITSR outputs generated via a SITSR machine learning model trained to generate a composite image from a plurality of two-dimensional images;

FIG. 5B shows another example of SITSR outputs generated via the SITSR machine learning model trained to generate a composite image from a plurality of two-dimensional images;

FIG. 6 shows an example overlay image output from an activity detection model according to one or more embodiments of the present disclosure;

FIG. 7 illustrates saliency maps showing localized activity in an image;

FIG. 8 is a flowchart illustrating a method of operation of an activity detection system;

FIG. 9 is a block diagram illustrating an example encoder-decoder architecture used for one or more machine learning techniques according to one or more embodiments of the present disclosure;

FIG. 10 shows a three-dimensional latent space output plot graph according to one or more embodiments of the present disclosure;

FIG. 11 shows an example one class Support Vector Machine (SVM) output plot graph according to one or more embodiments of the present disclosure; and

FIG. 12 is a block diagram of circuitry that, in some examples, may be used to implement various functions, operations, acts, processes, and/or methods disclosed herein.

### DETAILED DESCRIPTION

The amount of video surveillance data generated across the globe continues to increase exponentially over time. Not only is video surveillance data one of the most generated media format in the world, but it is also one of the most expensive to process. However, the analytics used to generate alerts responsive to activities in real time have not kept up with the rate at which data is collected. Object detection may be used in video surveillance systems and involves detecting a human and then triggering an alert or recording instance. One approach that may be used in activity detection involves video annotation that does not operate in real time and uses a completed video feed for annotation. Other approaches may include human skeleton tracking, deep recurrent architectures, optical flow, and single frame estimation. Human skeleton tracking involves pose tracking to capture activity detection and may be limited to human action. Deep recurrent architectures may involve significant computational requirements that make real-time activity detection difficult in high resolution. Optical flow involves tracking multiple single objects bounding boxes between frames to capture activity. Single frame estimation may involve a guess where a single frame containing the activity is labeled as an object. Humans can often detect activity just by looking at a single still frame of a video, but for object detection, that approach may not be generalizable to different types of activities. For example, looking at a single video frame of a car at a stop sign will not tell if the activity is stopping, turning, or accelerating.

Accordingly, one or more embodiments of the present disclosure may include an activity detection system that may detect activities performed by detected objects (e.g., human, vehicle, or animal, without limitation) by generating a composite image of a plurality of sampled video frames (e.g., via a machine learning model such as an autoencoder) and then providing the composite image to a machine learning model such as a single convolutional neural network (CNN) model for both classification and localization of one or more activities represented in the composite image. This approach may reduce reliance on recurrent layers that significantly slow down the recognition system. The composite image generated from a plurality of sampled video frames may be referred to as a Single Image Time Series Representation (SITSR) of the activity. The SITSR may be directly used by a single CNN model for both classification and localization of one or more activities represented in the SITSR (i.e., the composite image). Moreover, the various machine learning models (e.g., for composite image generation or detection, localization, and classification of activities represented in the composite image) discussed herein may be implemented in programmable logic of a programmable logic device included in a video capture device. This may allow for faster classification and enable real-time classification and localization of activities captured by a video feed of the video capture device.

The SITSR may be implemented by pre-processing the images or via layers prepended to traditional object-detection models. For example, an autoencoder (e.g., a variational autoencoder) may be trained to generate a SITSR given an input of a plurality of images. The generated SITSR may then be used as input for other machine learning models for detection, classification, localization, without limitation. Prepending SITSR creation to the beginning of machine learning models may mean that the weights used for averaging may be learned during model training and that the SITSR computation may not incur increased computational costs.

Furthermore, the activity detection system may be designed for real-time activity detection and the various models described herein may be designed specifically for deployment in inexpensive and low power field-programmable gate arrays (FPGAs) that can be directly integrated into a video camera device, thereby enabling activity detection using a video camera in real-time and negating the need to transmit large amounts of video data to a central location for processing.

The activities that a model may detect may be fully customizable. For example, a model may be trained for detecting activities including, but not limited to, a person carrying a heavy box, opening a car door, entering a car, closing a door, leaving a tool, picking up a tool, talking on a cellphone, texting on a cellphone, walking, running, falling asleep, opening a gate, lifting a datacenter floor panel, opening a rack door, removing a hard-drive, delivering a package, looking into a window, pausing from another activity, etc. Moreover, the detectable activities may not be human related. For example, they may include detecting a car turning left, turning right, stopping, or not stopping, without limitation.

Furthermore, in some embodiments the activity detection system may be configured to identify and localize unprecedented or anomalous activities. For example, an anomalous activity may include activities for which a model (e.g., an autoencoder model) has not been trained to recognize. As a specific, non-limiting example, a variational autoencoder may be trained on images including activities that are expected or benign. After the variational autoencoder has been trained, subsequent images including anomalous activities (i.e., activities not represented in the training data) may be identified based on the input images differing from the training data. Detecting anomalous activities may allow for real-time alert generation.

Accordingly, the activity detection system of the present disclosure may be configured for real-time anomalous activity detection in video surveillance footage.

As a specific, non-limiting example, the activity detection system may utilize hours of unlabeled video surveillance footage that is considered “normal” and contains no unprecedented activities for training a model (e.g., an autoencoder model). Once the model is trained, SITSRs representative of a sampled camera feed may be input into the trained model. If an activity that is represented in the SITSR is unprecedented (e.g., sufficiently dissimilar to features extracted from the “normal” data used to train the model), then the activity identified in the SITSR is flagged as anomalous. The anomaly may also be localized in the video footage image both in time and space. For example, the activity detection system may use data from the SITSR to localize activities identified in the SITSR via one or more image processing techniques.

The activity detection system may also allow for model analysis (e.g., all model analysis) to occur in real-time. In some embodiments, models used for anomalous activity detection may be trained using unsupervised learning whereas models used for detecting and classifying activity types may be trained using supervised learning.

Additionally, for datacenters alone, there are over 10,000 datacenters in the U.S. relying on significant video surveillance footage to secure their datacenter in the presence of external vendor service call visits. The activity detection system may be fully implementable as a co-processor on a video capture device (e.g., a video camera). Site-specific improvements to the model weights may be regularly updated as a service to eliminate false positives from any new benign activity. Identifying and localizing “weird” or “unprecedented” activities or identifying and classifying activities represented in video surveillance footage may benefit any site with a deployment of surveillance cameras including, but not limited to, airports, gas stations, university campuses, schools, national laboratories, nuclear reactor facilities, electronic exchanges, police departments, national parks, and home security systems.

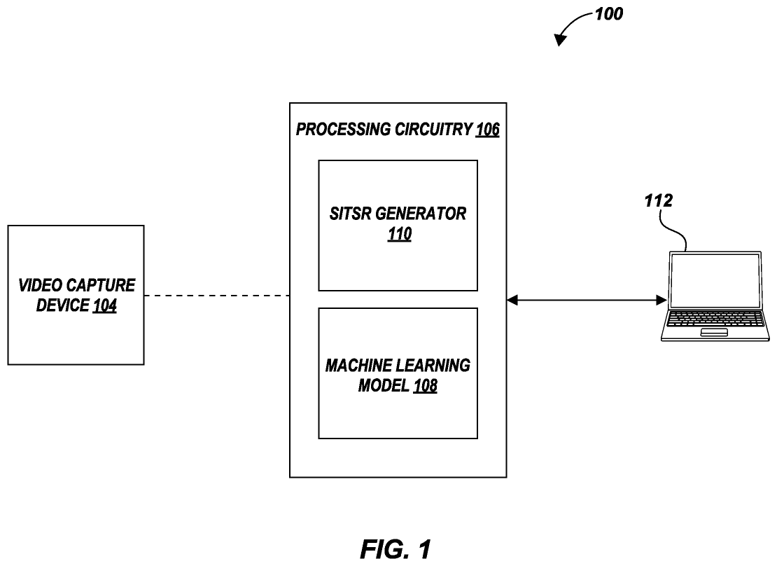

FIG. 1 is a schematic view of an activity detection system 100, in accordance with various embodiments of the disclosure. The activity detection system 100 may include a video capture device 104 and processing circuitry 106 operably coupled to the video capture device 104. The activity detection system 100 may also include a user device 112 that may be in communication with the processing circuitry 106. The video capture device 104 may be configured to capture a live video feed that may be represented as a plurality of two-dimensional images. The processing circuitry 106 may include a Single Image Time Series Representation (SITSR) generator 110 and a machine learning model 108.

The SITSR generator 110 may be configured to generate a composite image of a plurality of two-dimensional images. The composite image may represent a temporal structure of motion represented in the plurality of two-dimensional images. As a specific, non-limiting example, a series of two-dimensional images captured via an image capture device (e.g., the video capture device 104) may be taken from a single frame of reference or a dynamic frame of reference where each image captures a ball as it moves across the frame of reference. The SITSR (i.e., composite) image may visually represent the temporal structure of motion of the ball moving across the frame of reference in a single two-dimensional image.

The video capture device 104 may be configured to provide the processing circuitry 106 with a plurality of two-dimensional images representative of a video feed captured by the video capture device 104 where the plurality of two-dimensional images may represent a period of time captured by the video feed. One or more sets or subsets representing a period of time of a captured video feed may be provided to the SITSR generator 110 and the SITSR generator 110 may generate a SITSR (i.e., composite image) for each set or subset provided to the SITSR generator 110.

In some embodiments, the SITSR generator 110 may implement one or more machine learning models configured to generate a SITSR (i.e., composite image) given an input of a plurality of two-dimensional images. For example, an autoencoder trained (e.g., using unsupervised learning) may automatically extract one or more features from a plurality of two-dimensional images and encode the plurality of two-dimensional images into a latent space representation of the two-dimensional images (e.g., as one or more feature vectors). A decoder may then reconstruct the latent space representation to generate a single two-dimensional image based on the latent space representation of the plurality of two-dimensional images. For example, the decoder may be trained to reconstruct one or more feature vectors representative of a plurality of two-dimensional images as a single image depicting a temporal structure of motion represented in the plurality of two-dimensional images. Though discussed in terms of using an autoencoder that is used to generate a SITSR from a plurality of two-dimensional images, any method for generating a composite image from a set of two-dimensional images may be used including using other machine learning models or algorithms or non-machine learning methods. For example, a SITSR may be generated using pixel averaging across the plurality of two-dimensional images and/or using weighted averaging of pixels or any other conventional method of generating a composite image from a plurality of two-dimensional images.

After a SITSR has been generated by the SITSR generator 110, the SITSR may then be input into the machine learning model 108 to classify one or more activities represented in the SITSR and/or identify activities represented in the SITSR as anomalous or benign. For example, the machine learning model 108 may be in the form of a convolutional neural network (CNN) trained using labeled activity image data to enable the machine learning model 108 to classify activities represented in a SITSR. Moreover, the convolutional neural network may also be trained to localize a classified activity within the SITSR. For example, a SITSR showing a person walking in in a lower right corner of a two-dimensional image may identify the area within the image in the lower right corner of the image that includes the detected activity of walking. Furthermore, the processing circuitry 106 may be configured to label the SITSR responsive to the classification by the CNN and also generate a visual overlay for the SITSR with the label and an identifier to show where in the SITSR the classified activity is located. The overlay and/or the SITSR may then be transmitted to the user device 112 for display on a display of the user device 112. For example, a SITSR representative of a car turning may be input into the CNN. The CNN may then detect and classify the activity represented in the SITSR as a car turning and generate a label for the SITSR such as, for example, only, “CAR_TURNING.” The CNN may also generate location information identifying where in the image the classified activity was detected. For example, in some embodiments the system 100 may generate a localization (e.g., one or more indicators of a location or locations) of an activity that was detected in the SITSR. Using this data, the processing circuitry 106 may then generate an overlay based on the SITSR to identify the detected turning of the car and labeling the activity as a car turning. For example, the overlay may include a square encompassing the car represented in the SITSR, or a video feed of the video capture device 104 with a label proximate the square reading “CAR TURNING.” The SITSR and/or the overlay may then be sent to the user device 112 to be rendered on the display of the user device 112 or on a display included on the video capture device 104.

In some embodiments the machine learning model 108 may be in the form of an autoencoder trained using images showing “benign” or expected activities. For example, the autoencoder may be trained to extract features from a SITSR and represent those features as feature vectors in latent space. The feature vectors may cluster within latent space based on the features extracted from the “benign” or expected activities represented in the SITSR. After the autoencoder has been trained using the “benign” or expected image data, a SITSR input into the autoencoder representing an activity outside of the activities used in the training data may be spatially separate in latent space from the “benign” or expected data. Accordingly, an activity outside of a predetermined threshold (e.g., spatial distance in latent space from a center mass of a cluster of benign or expected feature vectors) may be identified as an anomalous activity. Though discussed in specific ways to ascertain anomalous activity, any conventional method or machine learning algorithm for determining anomalous data may be used. After an anomalous activity has been identified, an alarm or alert may be generated and sent to the user device 112 to alert a user of the identified anomalous activity. Each of the SITSR generator 110 and the machine learning model 108 may be implemented in programmable logic (e.g., a field programmable gate array (FPGA)).

The user device 112 may represent various types of computing devices with which a user can interact. For example, the user device 112 may be a mobile device (e.g., a cell phone, a smartphone, a PDA, a tablet, a laptop, a watch, a wearable device, etc.). The image capture device 104 may also be a non-mobile device such as a desktop that a number of peripheral devices (e.g., input/output devices such as a keyboard and mouse) may be connected to.

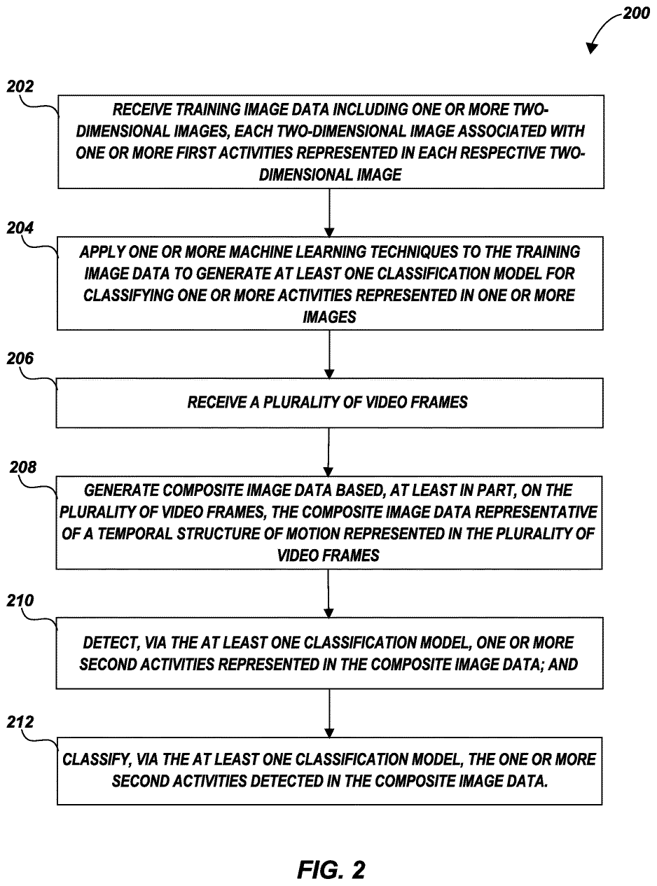

FIG. 2 is a flowchart illustrating a method 200 of operation of the activity detection system 100, according to various embodiments of the disclosure. For example, method 200 may be performed by a processor executing instructions stored on a computer-readable storage medium (e.g., performed by the processing circuitry 106). At operation 202, the activity detection system 100 receives training image data including one or more two-dimensional images, each two-dimensional image associated with one or more first activities represented in each respective two-dimensional image. In some embodiments, the training data may include labeling data labeling each respective two-dimensional image according to the one or more first activities represented in each respective two-dimensional image. As a specific, non-limiting example, an image used for training may depict or otherwise contain data related to an activity of a human walking. The image may then be labeled to indicate that the activity represented in the image is of a human walking. In some embodiments, each two-dimensional image may be a composite or SITSR that is based, at least in part, on a plurality of two-dimensional images. In some embodiments, one or more image processing techniques may be performed on the training image data before the training image data.

At operation 204, the activity detection system 100 applies one or more machine learning techniques to the training image data to generate at least one classification model for classifying one or more activities represented in one or more images. For example, a classifier machine learning model (e.g., a convolutional neural network (CNN)) may be trained using the training data and the labeling data. For instance, each of the one or more two-dimensional images may be input into the classifier machine learning model configured to classify each image based on an activity represented in each image. The classifier machine learning model may then generate a classification prediction based on the input image. The prediction is then compared to the actual or “truth” label corresponding to each respective two-dimensional image. Responsive to the comparison, the classifier machine learning model may automatically change one or more weights and or variables of the machine learning model. This process may be repeated until it is determined that accuracy of the classifications are within a predetermined accuracy threshold. Again referring to the example of the training data including image data relating to a person walking, the training data may comprise a SITSR image of a person walking and may be input into the classifier machine learning model. The classifier machine learning model may then make a classification prediction based on the input. The prediction is then compared to the label or “correct” classification. In response to the comparison, the classifier machine learning model may automatically change variables and/or weights of the classifier machine learning model.

At operation 206, the activity detection system 100 receives a plurality of video frames via the video capture device 104. For example, the plurality of video frames may include a series of video frames (e.g., discrete two-dimensional images) representative of a period of time of capture by the video capture device 104. In some embodiments, one or more image processing techniques may be performed on one or more of the received video frames. For example, image processing techniques may include edge detection, histogram equalization, noise reduction, edge enhancement, image sharpening, signal boosting, signal dampening, low pass filtering, high pass filtering, median filtering, adaptive median filtering, greyscale filtering, Gaussian filtering, Sobel filtering, Laplacian filtering, heat mapping, and/or thresholding, without limitation. In some embodiments the video frames may be generated at the video capture device 104 and sent to the processing circuitry 106, which may then perform the image processing techniques on the received video frames.

At operation 208, the activity detection system 100 may generate composite image data based, at least in part, on the plurality of video frames where the composite image data is representative of a temporal structure of motion represented in the plurality of video frames. For example, the plurality of video frames may be input into an encoder-decoder machine learning model (e.g., a variational autoencoder machine learning model) trained to generate a SITSR (i.e., composite image) representative of a temporal structure of motion represented in the plurality of video frames. In some embodiments, an encoder may be trained to encode data into a latent space representation of that data where the latent space representation may then be used as a SITSR. For example, an autoencoder may automatically extract one or more features from a plurality of two-dimensional images, such as video frames, and represent each of those features in latent space. This latent space representation of features may be used as the SITSR and represent a two-dimensional image representing the features extracted from the plurality of two-dimensional images. Accordingly, the composite image may be generated responsive to extracting one or more features from a plurality of two-dimensional images that have been encoded into a latent space representation of the one or more features. In other embodiments, the composite image may be generated by taking a weighted average (e.g., a weighted average of pixel values) of each of the plurality of video frames to generate a single composite image. After the composite image data is generated, one or more image processing techniques may be performed on the composite image data. Though described as a list of different applicable image processing techniques, any conventional image processing technique may be performed on the training image data, any of the plurality of video frames, a SITSR, or any other image discussed herein. In some embodiments, the plurality of video frames may be received via the video capture device 104 or from another device such as the user device 112.

At operation 210, the activity detection system 100 detects, via the at least one classifier machine learning model, one or more second activities represented in the composite image data. At operation 212, the activity detection system 100 classifies, via the at least one classifier machine learning model, the one or more second activities detected in the composite image data. The classifier machine learning model (e.g., machine learning model 108) may be trained to detect and classify any number of activities represented in the plurality of video frames. As non-limiting examples, the classification model may be trained to detect and classify actions such as a person carrying a heavy box, opening a car door, entering a car, closing a door, leaving a tool, picking up a tool, talking on a cellphone, texting on a cellphone, walking, running, falling asleep, opening a gate, lifting a datacenter floor panel, opening a rack door, removing a hard-drive, delivering a package, looking in a window, pausing from another activity, without limitation. Furthermore, activities that the classification model may be trained to classify are not limited to activities performed by humans. By way of non-limiting examples, the classification machine learning model may be trained to detect and classify a car turning left, turning right, stopping, or not stopping, without limitation.

Moreover, the classification machine learning model may also be trained to identify a location within a SITSR of a detected and/or classified activity. The activity detection system 100 may then generate one or more overlay images (e.g., overlay geometry, heatmaps, etc.) to visually identify the location of the detected activity. In some embodiments, classification of the composite image may include labelling the composite image responsive to the classification. Moreover, in some embodiments the activity detection system 100 may provide the overlay image to the video feed of the video capture device 104 itself. For example, the video feed may be continuously sampled such that a SITSR is generated in real time and a plurality of frames representative of a period of time (e.g., one second or two seconds, without limitation) may be sent to the processing circuitry 106 to generate a SITSR to detect and classify an activity represented in the SITSR and update an overlay over the video feed of the video capture device 104 in real time. The video feed may be viewed either at the video capture device 104 or at the user device 112.

In some embodiments, the classification model may be configured to classify the detected activity as anomalous. For example, if the detected activity falls outside of a predefined classification parameter (e.g., the machine learning model cannot classify the activity in a known class within a predefined confidence threshold) then the activity may be classified as anomalous. Furthermore, in some embodiments, the activity detection system 100 may be configured to generate one or more alarms or alerts responsive to classifying the detected activity. For example, the activity detection system 100 may be configured to generate one or more alarms or alerts responsive to an activity being classified as an activity known to be, for example, anomalous, violent, and/or illegal. For example, the activity detection system 100 may be configured to automatically generate an alert or an alarm if an activity such as swinging a bat or other object is detected and classified as such. The alarm or alert may be transmitted to the user device 112 and cause the user device 112 to display the alert or alarm and/or generate sounds indicative of the alarm or alert.

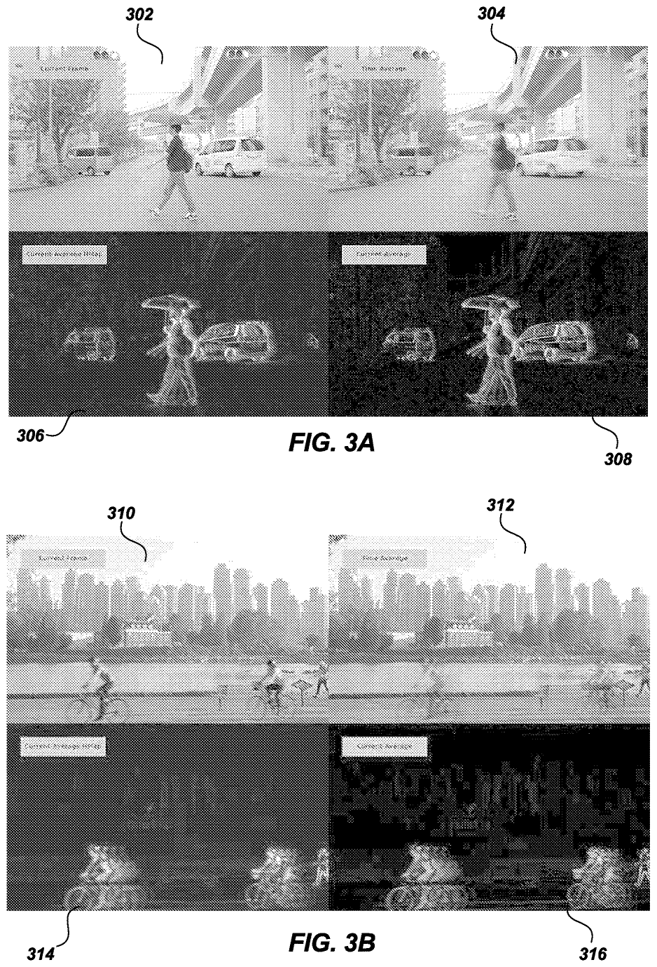

FIG. 3A shows various states of processing a single image time series representation (SITSR) generated by weighted averaging of a plurality of two-dimensional images. For example, the images show a current frame 302 representing one of a plurality of two-dimensional images, a time average 304 of a plurality of images, a current-average 308 to emphasize areas of change (e.g., visualizing the differences in each of the plurality of two-dimensional images relative to each other) represented in the time average 304 of the plurality of two-dimensional images, and a current-average heat maps 306 of the current-average 308 to visually enhance the areas of change represented in the time average 304. SITSR turns a time series of images into a single image depicting motion in the time series. The time series of images may be taken with respect to a static reference frame or a dynamic reference frame using a Kalman or similar filter, image stitching, or other conventional methods of generating an image from a plurality of images taken from a dynamic reference frame. SITSR represents a way to compress time series representations to a single image (2D array) which may enable the avoidance of computationally heavy operations like an attention mechanism. SITSR may be used for real-time inference such as in programmable logic implementations. FIG. 3B shows various states of processing a second SITSR generated by weighted averaging of a plurality of two-dimensional images. Similar to FIG. 3A, FIG. 3B shows a current frame 310, a time average 312, a current-average 316, and a current-average heat map 314 to illustrate various views of a SITSR representing an activity different from that shown in FIG. 3A.

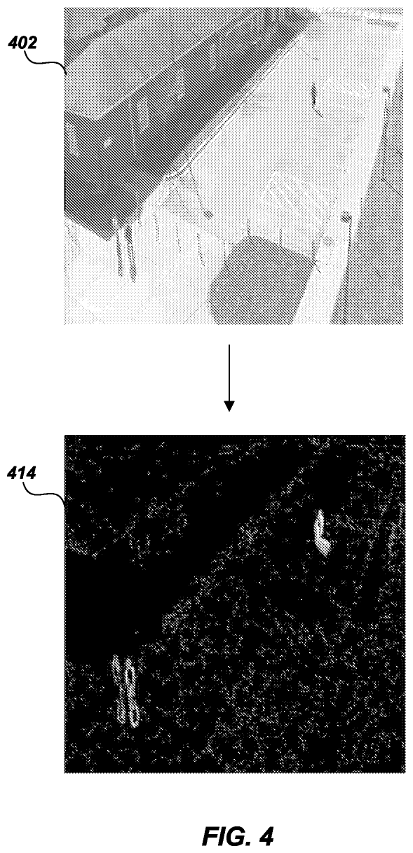

FIG. 4 shows a SITSR 402 representative of a period of time captured by a video capture device (e.g., video capture device 104; see FIG. 1). Processed image 414 shows a SITSR showing only the change over time between a plurality of images used to generate the SITSR shown in image 402. In some embodiments, the SITSR may be used to localize detected activities represented in the SITSR. For example, as shown in processed image 414, a temporal structure of motion may be detected by examining change over a series of two-dimensional images where the areas where there is a change may be the location of a detected activity.

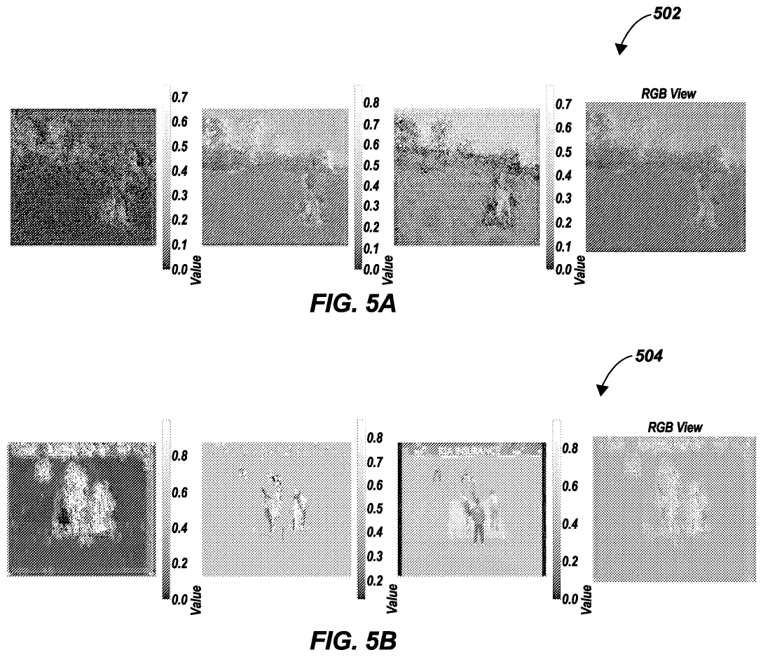

FIG. 5A shows example SITSR outputs 502 generated via a SITSR machine learning model trained to generate a composite image from a plurality of two-dimensional images. FIG. 5B shows another example of SITSR outputs 504 generated via the SITSR machine learning model trained to generate a composite image from a plurality of two-dimensional images. Referring to FIG. 5A and FIG. 5B together, the SITSR generator 110 (see FIG. 1) may include a SITSR machine learning model trained to generate a composite image from a plurality of two-dimensional images. Moreover, the SITSR machine learning model may be incorporated with other machine learning models (e.g., the machine learning model 108) to form an ensemble model configured to extract features from a plurality of two-dimensional images, generate a SITSR from the plurality of two-dimensional images, and detect and classify activities or detect anomalous activities within the SITSR. For example, the machine learning model 108 may be in the form of a computer vision model (e.g., a single shot detector (SSD) model or a you only look once (YOLO) model, without limitation) where the computer vision model uses the output of the SITSR machine learning model to generate classifications or anomaly detections for activities represented in the SITSR (e.g., SITSR outputs 502 or 504). FIG. 5A and FIG. 5B show various SITSR images generated by a machine learning model at different points in the training iterations and/or after being subjected to one or more image processing techniques. The more iterations, the better the SITSR may capture the activity (or features of the activity) represented in the SITSR for recognition by a computer. For example, a SITSR generated via a machine learning model may be generated to be recognized by a computer (e.g., computer vision software). Thus, though shown in FIGS. 5A and 5B having generally discernable activities, some SITSRs may be in a form such that a human may not be able to readily ascertain what the SITSR represents or any activities represented therein, but rather may be in a form designed for a computer program or machine learning model to receive in order to detect one or more activities and/or localizations of the detected activities based on the SITSR.

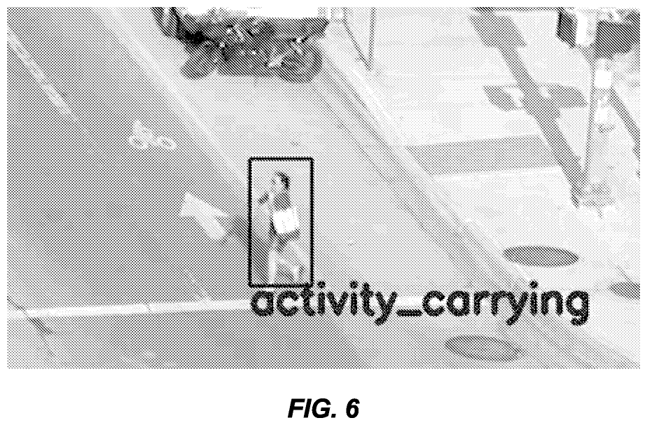

FIG. 6 shows an example output of the activity detection system 100 (see FIG. 1) showing an overlay generated responsive to a detected, labeled, and localized activity represented in a video feed of a video capture device (e.g., the video capture device 104). The output may include an overlay image including a visualization of a location within the image and a label to be displayed over an image, a SITSR, or a live video feed showing the location and type of an activity detected by the activity detection system 100. For example, as shown in FIG. 6, the image detection system may label an image outlining the location in the image or live video feed of a detected activity as well as a label showing what type of activity has been detected.

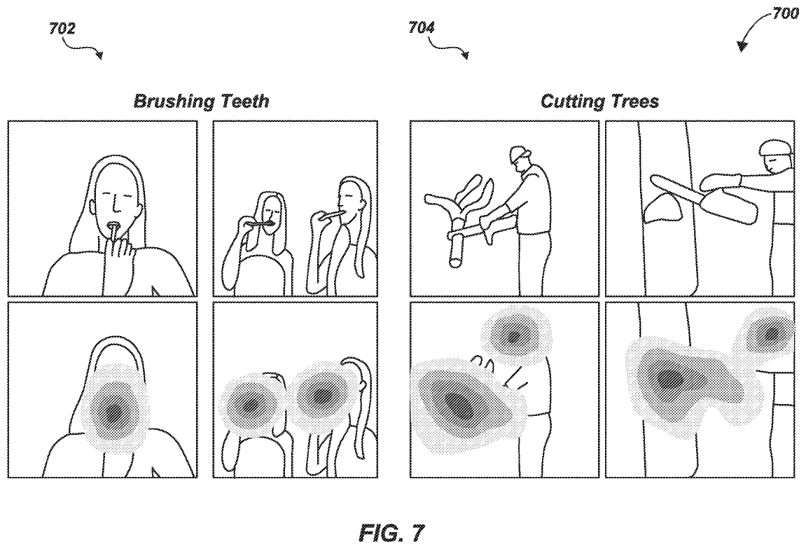

FIG. 7 illustrates saliency maps for localization (e.g., determining where and what activity occurred in a SITSR). The saliency maps 700 may be created with parameters from the encoder and allow people to see what features the model the model focused on to classify the activity or to determine whether the activity was an anomalous or “benign” activity. The saliency maps may be overlayed onto an image or onto a live video feed of a video capture device (e.g., video capture device 104). For example, FIG. 7 shows a series of images 702 depicting an activity identified as brushing teeth and a series of images 704 depicting on activity identified as cutting trees. The bottom images of each series of images 702 and 704 show saliency or heat maps overlayed onto the images depicting the activity. Though shown in FIG. 7 as opaque, the saliency or heat maps may have varying degrees of translucency so that the underlying activity may still be seen when the saliency or heat map is overlayed onto an image or onto a live video feed of a video capture device.

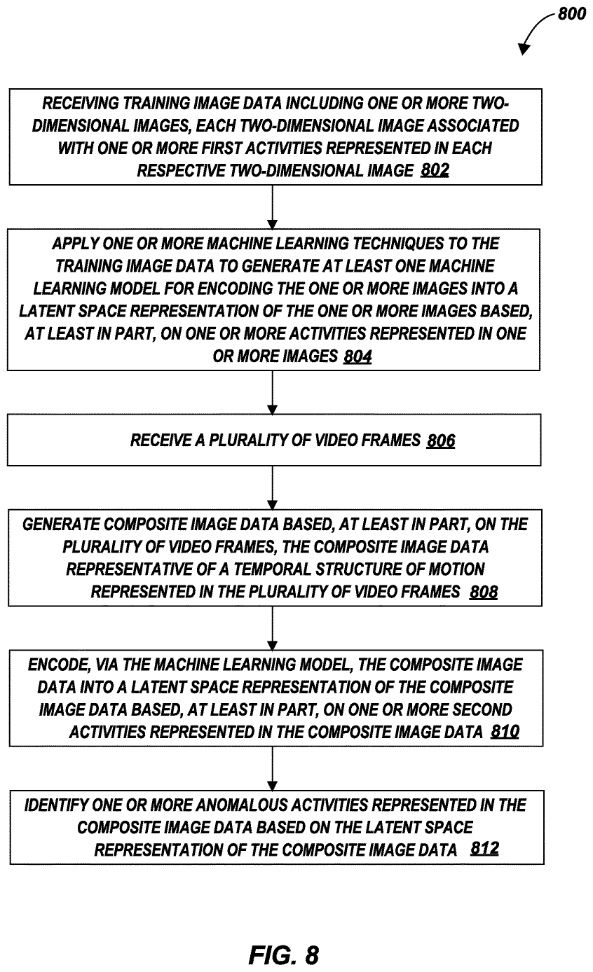

FIG. 8 is a flowchart illustrating a method 800 of operation of the activity detection system 100, according to various embodiments of the disclosure. For example, method 800 may be performed by a processor executing instructions stored on a computer-readable storage medium (e.g., performed by the processing circuitry 106). At operation 802, the activity detection system 100 receives training image data including one or more two-dimensional images, each two-dimensional image associated with one or more first activities represented in each respective two-dimensional image. At operation 804, the activity detection system 100 applies one or more machine learning techniques to the training image data to generate at least one anomaly detection machine learning model for encoding the one or more images into a latent space representation of the one or more images based, at least in part, on one or more activities represented in one or more images. For example, in some embodiments the at least one anomaly detection machine learning model may be in the form of an autoencoder (e.g., a variational autoencoder). The training image data may represent known “benign” or expected activities such as, as a non-limiting example, walking on a sidewalk or a handshake. The autoencoder may then automatically extract one or more features of the training image data and use the extracted features to encode the training image data in latent space as a reduced dimensionality representation. The latent space representation of the training image data is then reconstructed by a decoder to reconstruct the input data. The encoder may then measure the accuracy of the reconstruction such as, for example, measuring a magnitude of the reconstruction loss. This process may repeat until the reconstruction loss is within a predetermined threshold. In this way, an autoencoder may be trained to encode and reconstruct data corresponding to known “benign” or expected activities, but will struggle (i.e., will measure a high magnitude of reconstruction loss) to reconstruct data it was not trained on. Accordingly, data outside of a predetermined threshold for construction loss may be identified as anomalous.

At operation 806, the activity detection system 100 receives a plurality of video frames. For example, the plurality of video frames may be generated by the video capture device 104 and transmitted to the processing circuitry 106. At operation 808, the activity detection system 100 generates composite image data based, at least in part, on the plurality of video frames, the composite image data representative of a temporal structure of motion represented in the plurality of video frames. For example, a composite image may be generated via a machine learning model or via weighted averaging of a plurality of two-dimensional images as discussed above with regard to FIG. 2. At operation 810, the activity detection system 100 encodes, via the anomaly detection machine learning model, the composite image data into a latent space representation of the composite image data based, at least in part, on one or more second activities represented in the composite image data. At operation 812, the activity detection system 100 identifies one or more anomalous activities represented in the composite image data based, at least in part, on the latent space representation of the composite image data. For example, in the case where the anomaly detection machine learning model includes a decoder, a decoder may reconstruct the data and the anomaly detection machine learning model may calculate the reconstruction loss for the reconstruction of the data from the latent space representation. The activity detection system 100 may then identify the reconstructed data as anomalous responsive to the reconstruction loss exceeding a predetermined threshold.

Furthermore, in some embodiments the activity detection system 100 may identify an activity represented in the composite image as anomalous based on the spatial position of the composite image data encoded into latent space. In latent space, data exhibiting similar features may be clustered together. Accordingly, anomalous data may be spatially separate from the training data in latent space such that a data point outside of a predetermined spatial distance in latent space from data points known to be “benign” or expected may be identified as anomalous.

Once an anomalous activity has been identified, the activity detection system 100 may generate or cause the user device 112 to generate an alarm or alert. For example, in some embodiments the alarm or alert may be in the form of a graphical user interface (GUI) element appearing on a display of the user device 112 and/or an audio sample played on the user device 112.

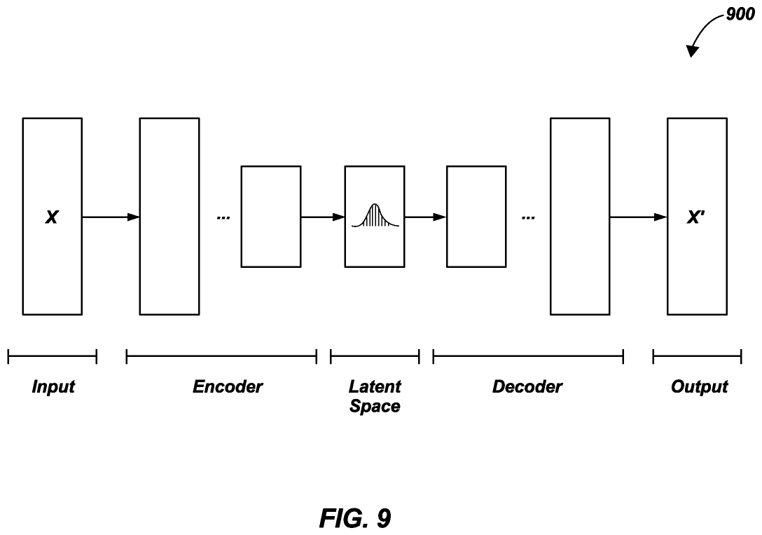

FIG. 9 is a diagram 900 illustrating an example encoder-decoder architecture used for one or more machine learning techniques. An encoder (e.g., an auto-encoder, variational auto-encoder, etc.) turns an input into a compressed representation of the input. The set of encoder outputs (e.g., all encoder outputs) is called the latent space. Data in the latent space may be passed into a decoder to get an approximation of the original input data by reconstructing the latent space representation of the input data.

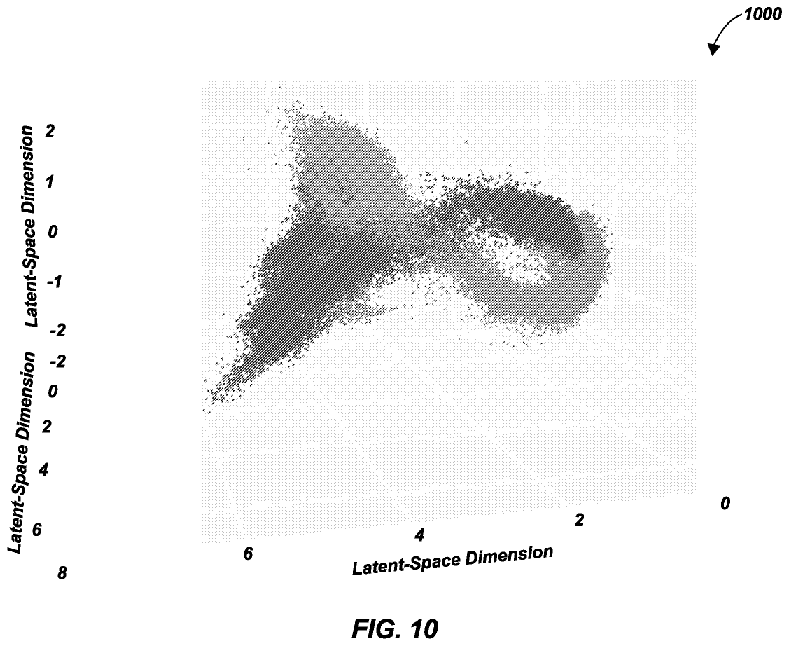

FIG. 10 shows a three-dimensional latent space output graph 1000. The graph 1000 is a 3D plot of points in a representative latent space. For illustration, the grey data points represent activities represented in latent space that have been identified as anomalous and the black points represent activities represented in latent space that have been identified as “benign” or expected activities. The separation between the anomalous and normal activities is one way that identification of anomalous activity is possible, as a boundary may be drawn around most of the normal points. Additionally, there are other statistical properties that allow other anomaly detection methods to be used. Example anomaly detectors may include, but are not limited to, a one class support vector machine (SVM)/one class neural network, statistical methods, and/or K-nearest neighbors.

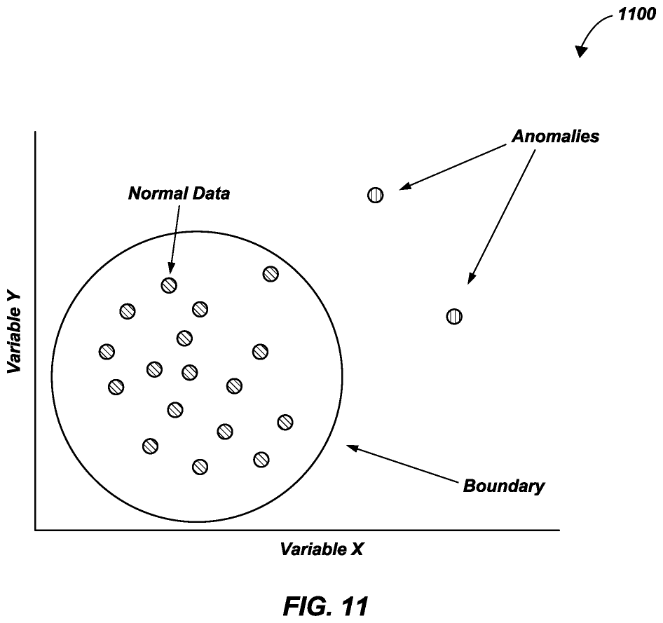

FIG. 11 shows an example one class SVM output plot graph 1100. As shown in FIG. 11, for a one class SVM, a boundary may be drawn around the normal points and anything outside may be considered anomalous and data points inside the boundary may be considered normal, “benign,” and/or expected. Graph 1100 is a simplified example to show how a boundary may be draw to differentiate data points represented in latent space, but more sophisticated boundaries methods are contemplated, including techniques that have more complex classification for points near the boundary. Though discussed in terms of specific anomaly detection algorithms, any anomaly or other classification algorithms may be used including any conventionally known classification or anomaly detection algorithm. For example, other methods may take advantage of either the separation between normal and anomalous data in the latent space or the statistical properties of the data for finding anomalies.

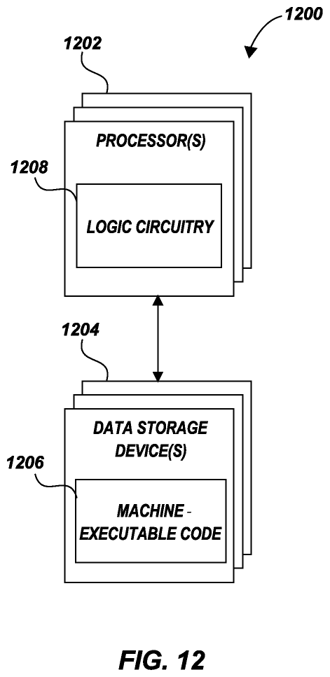

It will be appreciated by those of ordinary skill in the art that functional elements of examples disclosed herein (e.g., functions, operations, acts, processes, and/or methods) may be implemented in any suitable hardware, software, firmware, or combinations thereof. FIG. 12 illustrates non-limiting examples of implementations of functional elements disclosed herein. In some examples, some or all portions of the functional elements disclosed herein may be performed by hardware specially configured for carrying out the functional elements.

FIG. 12 is a block diagram of circuitry 1200 that, in some examples, may be used to implement various functions, operations, acts, processes, and/or methods disclosed herein. The circuitry 1200 includes one or more processors 1202 (sometimes referred to herein as “processors 1202”) operably coupled to one or more data storage devices 1204 (sometimes referred to herein as “storage 1204”). The storage 1204 includes machine-executable code 1206 stored thereon and the processors 1202 include logic circuitry 1208. The machine-executable code 1206 includes information describing functional elements that may be implemented by (e.g., performed by) the logic circuitry 1208. The logic circuitry 1208 is adapted to implement (e.g., perform) the functional elements described by the machine-executable code 1206. The circuitry 1200, when executing the functional elements described by the machine-executable code 1206, should be considered as special purpose hardware configured for carrying out functional elements disclosed herein. In some examples the processors 1202 may perform the functional elements described by the machine-executable code 1206 sequentially, concurrently (e.g., on one or more different hardware platforms), or in one or more parallel process streams.

When implemented by logic circuitry 1208 of the processors 1202, the machine-executable code 1206 is to adapt the processors 1202 to perform operations of examples disclosed herein. For example, the machine-executable code 1206 may adapt the processors 1202 to perform at least a portion or a totality of the method 200 of FIG. 2, or the method 800 of FIG. 8. As another example, the machine-executable code 1206 may adapt the processors 1202 to perform at least a portion or a totality of the operations of the apparatus of FIG. 1 and the architecture of FIG. 9. For example, the machine-executable code 1206 may adapt the processors to perform the operations shown in FIGS. 2 and 8.

The processors 1202 may include a general purpose processor, a special purpose processor, a central processing unit (CPU), a microcontroller, a programmable logic controller (PLC), a digital signal processor (DSP), an application-specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to the machine-executable code 1206 (e.g., software code, firmware code, hardware descriptions) related to examples of the present disclosure. It is noted that a general-purpose processor (may also be referred to herein as a host processor or simply a host) may be a microprocessor, but in the alternative, the processors 1202 may include any conventional processor, controller, microcontroller, or state machine. The processors 1202 may also be implemented as a combination of computing devices, such as a combination of a DSP and a microprocessor, a plurality of microprocessors, one or more microprocessors in conjunction with a DSP core, or any other such configuration.

In some examples the storage 1204 includes volatile data storage (e.g., random-access memory (RAM)), non-volatile data storage (e.g., Flash memory, a hard disc drive, a solid state drive, erasable programmable read-only memory (EPROM), etc.). In some examples the processors 1202 and the storage 1204 may be implemented into a single device (e.g., a semiconductor device product, a system on chip (SOC), etc.). In some examples the processors 1202 and the storage 1204 may be implemented into separate devices.

In some examples the machine-executable code 1206 may include computer-readable instructions (e.g., software code, firmware code). By way of non-limiting example, the computer-readable instructions may be stored by the storage 1204, accessed directly by the processors 1202, and executed by the processors 1202 using at least the logic circuitry 1208. Also by way of non-limiting example, the computer-readable instructions may be stored on the storage 1204, transferred to a memory device (not shown) for execution, and executed by the processors 1202 using at least the logic circuitry 1208. Accordingly, in some examples the logic circuitry 1208 includes electrically configurable logic circuitry 1208.

In some examples the machine-executable code 1206 may describe hardware (e.g., circuitry) to be implemented in the logic circuitry 1208 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG™, SYSTEMVERILOG™ or very large-scale integration (VLSI) hardware description language (VHDL™) may be used.

HDL descriptions may be converted into descriptions at any of numerous other levels of abstraction as desired. As a non-limiting example, a high-level description may be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 1208 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine-executable code 1206 may include an HDL, an RTL, a GL description, a mask level description, other hardware description, or any combination thereof.

In examples where the machine-executable code 1206 includes a hardware description (at any level of abstraction), a system (not shown, but including the storage 1204) may implement the hardware description described by the machine-executable code 1206. By way of non-limiting example, the processors 1202 may include a programmable logic device (e.g., an FPGA or a PLC) and the logic circuitry 1208 may be electrically controlled to implement circuitry corresponding to the hardware description into the logic circuitry 1208. Also by way of non-limiting example, the logic circuitry 1208 may include hard-wired logic manufactured by a manufacturing system (not shown, but including the storage 1204) according to the hardware description of the machine-executable code 1206.

Regardless of whether the machine-executable code 1206 includes computer-readable instructions or a hardware description, the logic circuitry 1208 is adapted to perform the functional elements described by the machine-executable code 1206 when implementing the functional elements of the machine-executable code 1206. It is noted that although a hardware description may not directly describe functional elements, a hardware description indirectly describes functional elements that the hardware elements described by the hardware description are capable of performing.

In the preceding detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments enabled herein may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. In some instances, similar structures or components in the various drawings may retain the same or similar numbering for the convenience of the reader; however, the similarity in numbering does not necessarily mean that the structures or components are identical in size, composition, configuration, or any other property.

The preceding description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawings could be arranged and designed in a wide variety of different configurations. Thus, the following description of various embodiments is not intended to limit the scope of the present disclosure, but is merely representative of various embodiments. While the various aspects of the embodiments may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a digital signal processor (DSP), an Integrated Circuit (IC), an Application-Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, the term “benign,” when used in conjunction with terms such as activities represented in an image or composite image refers to activities that are known, classified, labeled, or identified to be expected or acceptable.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc. ,” or “one or more of A, B, and C, etc. ,” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the present disclosure as hereinafter claimed along with their legal equivalents. In addition, features from one example may be combined with features of another example while still being encompassed within the scope of the present disclosure.

1. An activity detection system comprising:
a video capture device;
at least one processor;
at least one non-transitory computer-readable medium storing instructions thereon that, when executed by the at least one processor, cause the at least one processor to:
receive training image data including one or more two-dimensional images, each two-dimensional image associated with one or more first activities represented in each respective two-dimensional image;
apply one or more machine learning techniques to the training image data to generate at least one classification model for classifying one or more activities represented in one or more images;
receive a plurality of video frames;
generate composite image data based, at least in part, on the plurality of video frames, the composite image data representative of a temporal structure of motion represented in the plurality of video frames;
detect, via the at least one classification model, one or more second activities represented in the composite image data; and
classify, via the at least one classification model, the one or more second activities detected in the composite image data.

2. The activity detection system of claim 1, wherein the instructions stored on the at least one non-transitory computer-readable storage medium, when executed by the processor, cause the activity detection system to identify locations of one or more second activities detected in the composite image data.

3. The activity detection system of claim 1, wherein the instructions stored on the at least one non-transitory computer-readable storage medium, when executed by the processor, cause the activity detection system to label the composite image data responsive to classifying the one or more second activities detected in the composite image data.

4. The activity detection system of claim 1, wherein the at least one classification model is deployed in programmable logic of a programmable logic device.

5. The activity detection system of claim 1, wherein the instructions stored on the at least one non-transitory computer-readable storage medium, when executed by the processor, cause the activity detection system to:
apply one or more image processing techniques to the training image data; and
apply one or more image processing techniques to the composite image data.

6. The activity detection system of claim 5, wherein the one or more image processing techniques include at least one technique selected from among the group consisting of edge detection, histogram equalization, noise reduction, edge enhancement, image sharpening, signal boosting, signal dampening, low pass filtering, high pass filtering, median filtering, adaptive median filtering, greyscale filtering, Gaussian filtering, Sobel filtering, Laplacian filtering, heat mapping, and/or thresholding.

7. The activity detection system of claim 1, wherein one or more activities represented in one or more of the training image data or the composite image data are indicative of one or more activities performed by a person.

8. The activity detection system of claim 1, wherein one or more activities represented in one or more of the training image data or the composite image data are indicative of one or more activities performed by a vehicle.

9. The activity detection system of claim 1, wherein the instructions stored on the at least one non-transitory computer-readable storage medium, when executed by the processor, cause the activity detection system to classify, via the at least one generated classification model, the one or more second activities detected as anomalous responsive to the classified one or more second activities falling outside of predefined classification parameters.

10. The activity detection system of claim 9, wherein the composite image data is classified as anomalous responsive to a determination, via the at least one generated classification model, that the one or more second activities represented in the composite image data falls outside of predefined classification parameters.

11. The activity detection system of claim 9, wherein the instructions stored on the at least one non-transitory computer-readable storage medium, when executed by the processor, cause the activity detection system to generate an alarm or alert responsive to classifying the composite image data.

12. The activity detection system of claim 1, wherein the instructions stored on the at least one non-transitory computer-readable storage medium, when executed by the processor, cause the activity detection system to provide one or more overlays to a video feed of the video capture device, the one or more overlays identifying a type or location of the one or more second activities represented in the video feed.

13. The activity detection system of claim 12, wherein the one or more machine learning techniques are deployed in programmable logic of a programmable logic device.

14. The activity detection system of claim 1, wherein the instructions stored on the at least one non-transitory computer-readable storage medium, when executed by the processor, cause the activity detection system to classify, via the at least one classification model, one or more activities of the one or more second activities as normal responsive to the one or more activities falling within predefined classification parameters.

15. A method comprising:
receiving training image data including one or more two-dimensional images, each two-dimensional image associated with one or more first activities represented in each respective two-dimensional image;
applying one or more machine learning techniques to the training image data to generate at least one machine learning model for encoding the one or more two-dimensional images into a latent space representation of the one or more two-dimensional images based, at least in part, on one or more activities represented in the one or more two-dimensional images;
receiving a plurality of video frames;
generating composite image data based, at least in part, on the plurality of video frames, the composite image data representative of a temporal structure of motion represented in the plurality of video frames;
encoding, via the at least one machine learning model, the composite image data into a latent space representation of the composite image data based, at least in part, on one or more second activities represented in the composite image data; and
identifying one or more anomalous activities represented in the composite image data based on the latent space representation of the composite image data.

16. The method of claim 15, wherein generating the composite image data further comprises generating the composite image data via an autoencoder model configured to generate a composite image based, at least in part, on a plurality of two-dimensional images.

17. The method of claim 15, further comprising identifying a location in the composite image data of the one or more second activities detected in the composite image data.

18. The method of claim 15, wherein identifying one or more anomalous activities further comprises determining that the one or more second activities are different from the one or more first activities used to train at least one classification model.

19. The method of claim 18, further comprising generating an alert responsive to classifying the one or more second activities as anomalous activities.

20. A non-transitory computer-readable medium storing instructions thereon that, when executed by at least one processor, cause the at least one processor to perform steps comprising:
receiving training image data including a plurality of first video frames;
providing the training image data to an auto-encoder machine learning model to train the auto-encoder machine learning model based, at least in part, on one or more first activities represented in the training image data;
receiving a plurality of second video frames;
generating composite image data based, at least in part, on the plurality of second video frames, the composite image data representative of a temporal structure of motion represented in the plurality of second video frames;
detecting, via the auto-encoder machine learning model, one or more second activities represented in the composite image data; and
identifying, via the auto-encoder machine learning model, the one or more second activities as anomalous responsive to a determination that the one or more second activities are different from the one or more first activities.
